(19) United States
(12) Patent Application Publication
(10) Pub. No.: US 2005/0274866 A1
(43) Pub. Date: Dec. 15, 2005

(54) Sculpture base

(76) Inventor: Yi-Chung Hsieh, Taipei (TW)

Correspondence Address: BINGHAM, MCCUTCHEN LLP, THREE EMBARCADERO CENTER, 18 FLOOR, SAN FRANCISCO, CA, 94111-4067, US

(21) Appl. No.: 10/864,350

(22) Filed: Jun. 10, 2004

(51) Int. Cl. F21V 7/00; A47G 29/00

(52) U.S. Cl. 248/346.01

(57) ABSTRACT

A sculpture base includes an inner space, a flat top face for supporting thereon the skeleton, and multiple through holes defined through the flat top face for extension of skeleton steel wires. A knot inside the inner space is formed by the skeleton steel wires extending through the through holes and the skeleton is securely supported by the flat top face.

### BACKGROUND OF THE INVENTION

1. Field of the Invention

The present invention relates to a base, and more particularly to a sculpture base for securely supporting a skeleton frame for receiving a sculpture.

2. Description of Related Art

With reference to FIG. 8, a conventional sculpture base (70) is shown to support thereon a skeleton (80) providing a frame for receiving a sculpture. In order to securely support the skeleton (80) on top of the base (70), at least one fixing element (81) is added and sandwiched between the skeleton (80) and the base (70) and at least one securing element (71) is provided to extend through the skeleton (80) and into the base (70) so as to securely support the skeleton (80) on top of the base (70). However, due to the addition of the fixing element (81), when clay is applied on the skeleton (80), an unusual bump is formed at the foot of the sculpture, which spoils the overall appearance of the sculpture. Therefore, artists try their best to cover the bump so that the bump is not too obvious to spoil the beauty of the sculpture. Therefore, it is to say that the conventional sculpture is not very user friendly. Furthermore, to extend the securing element (71) into the base (70), manual labor including the preparation of auxiliary tools and hands-on work to practically extend the securing element (71) into the base (70) troubles the operator.

To overcome the shortcomings, the present invention tends to provide an improved sculpture base to mitigate the aforementioned problems.

### SUMMARY OF THE INVENTION

The primary objective of the present invention is to provide an improved sculpture base to allow the operator to easily and securely support the skeleton for receiving a sculpture on top of the base without the need of auxiliary tools.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the sculpture base of the present invention;

FIG. 2 is a cross sectional view of the sculpture base in FIG. 1;

FIG. 3 is a schematic view showing that a skeleton is supported on top of the sculpture base of the present invention;

FIG. 4 is a schematic view showing how the skeleton is secured to the sculpture base of the present invention;

FIG. 5 is a cross sectional view of the sculpture base of another embodiment of the present invention;

FIG. 6 is a schematic view showing how the skeleton is secured to the second embodiment of the present invention;

FIG. 7 is a schematic view showing that clay is applied to the skeleton on top of the sculpture base of the second embodiment of the present invention; and

FIG. 8 is a perspective view of a conventional sculpture base.

### DETAILED DESCRIPTION OF THE PREFERRED EMBODIMENT

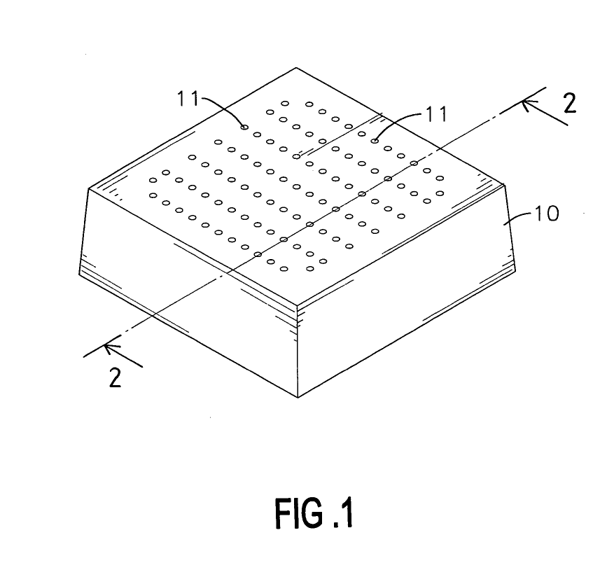

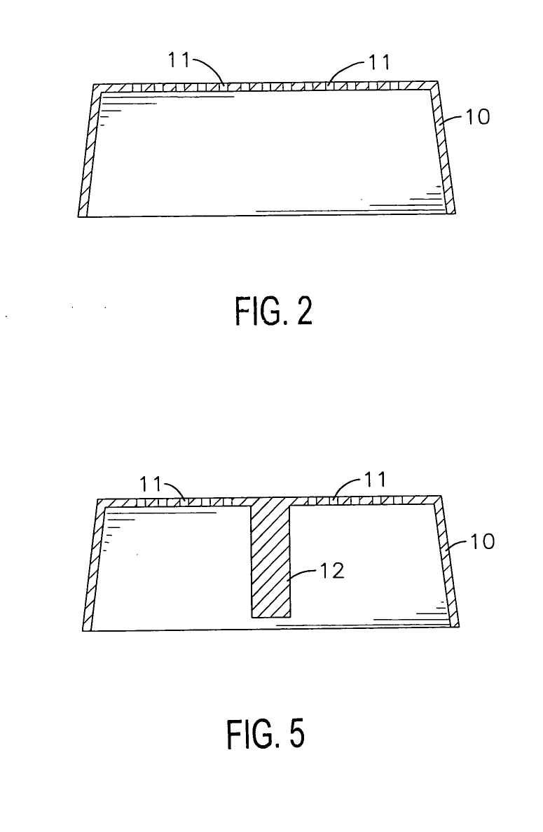

With reference to FIGS. 1 and 2, it is noted that the sculpture base (10) in accordance with the present invention is hollow and has a rectangular shape such that the sculpture base (10) has an inner space. However, the rectangular shape is not aimed to limit the shape of the present invention. The sculpture base of the present invention can be of any shape as long as the base has a flat bottom face for engagement with a surface and flat top face for supporting thereon a skeleton.

The sculpture base (10) has multiple through holes (11) defined through the top face of the sculpture base (10) to communicate with the inner space. Preferably, the through holes (11) are arranged in array.

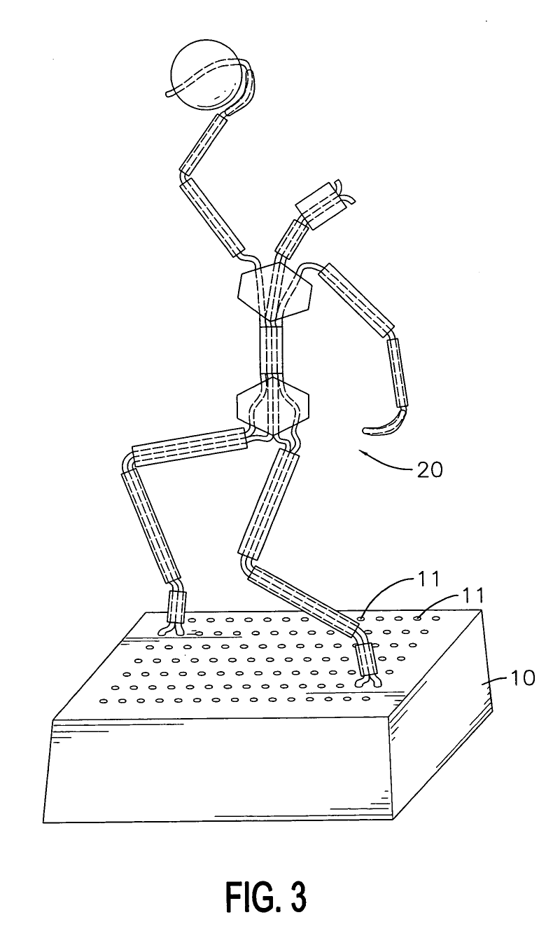

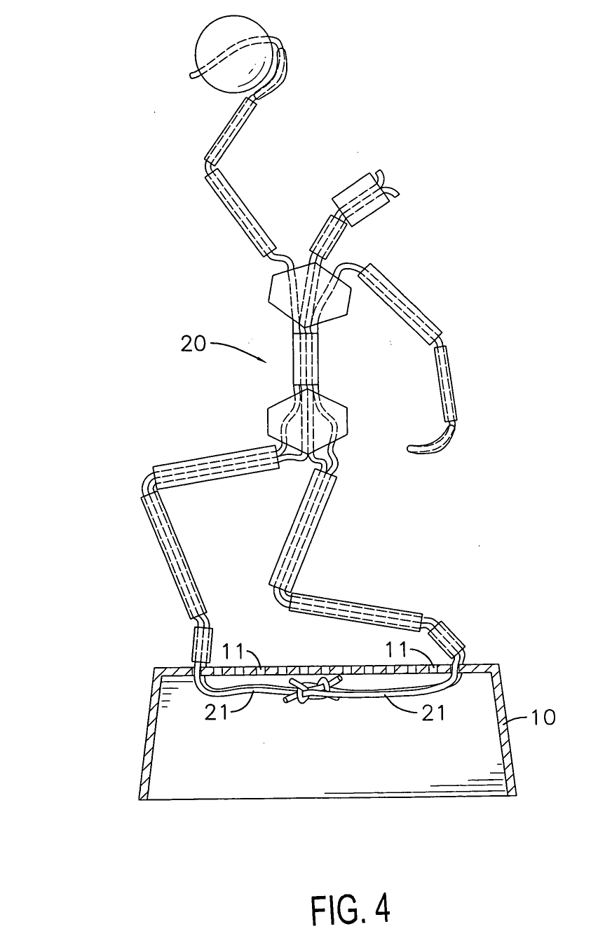

With reference to FIGS. 3 and 4, when a skeleton (20) is to be mounted on top of the sculpture base (10) of the present invention, the operator is able to use the skeleton steel wires (21) to extend through appropriate through holes (11) and tie them in a knot inside the sculpture base (10) such that the skeleton (20) is able to steadily stand on top of the sculpture base (10).

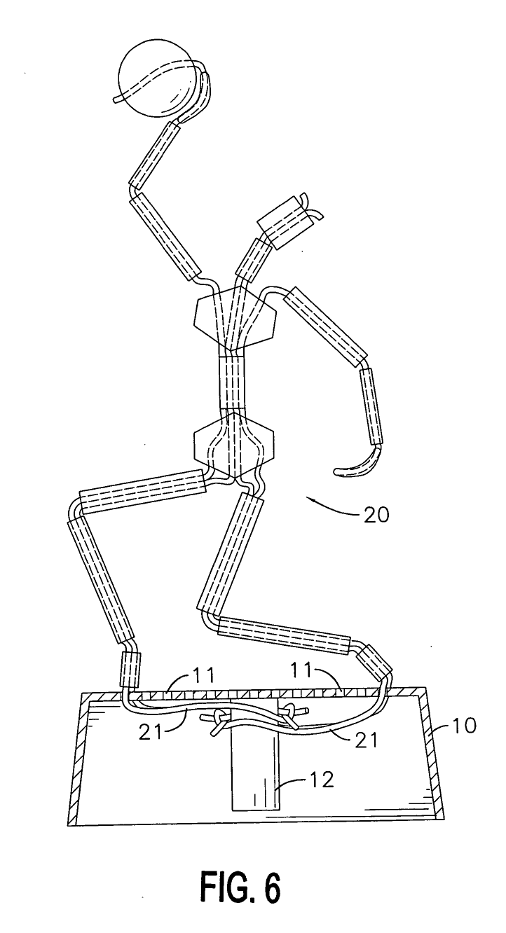

With reference to FIGS. 5 and 6, a different embodiment of the present invention is shown to have a securing rod (12) extending from a bottom face of the top face of the sculpture base (10) of the present invention.

When the skeleton (20) is to stand on top of the sculpture base (10), the operator is able to use the skeleton steel wire (21) to extend through appropriate through holes (11) and tie them in a knot around the securing rod (12) such that the skeleton (20) is able to steadily stand on top of the sculpture base (10).

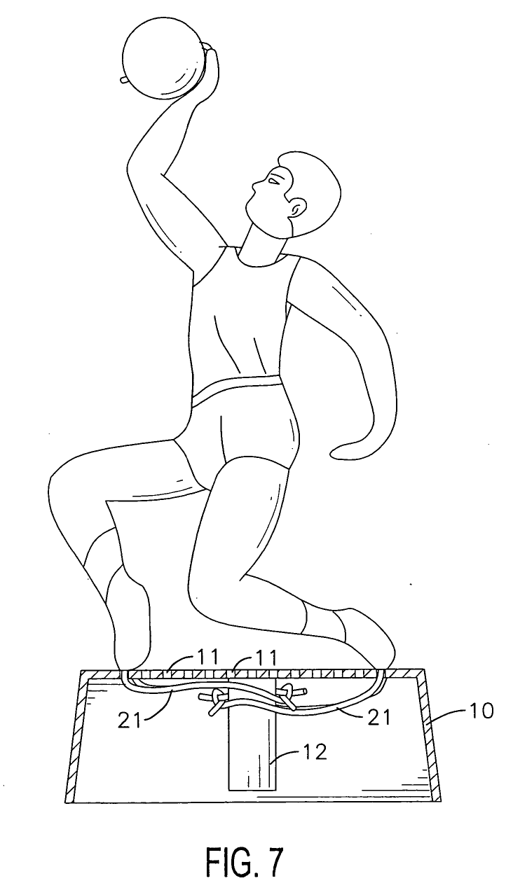

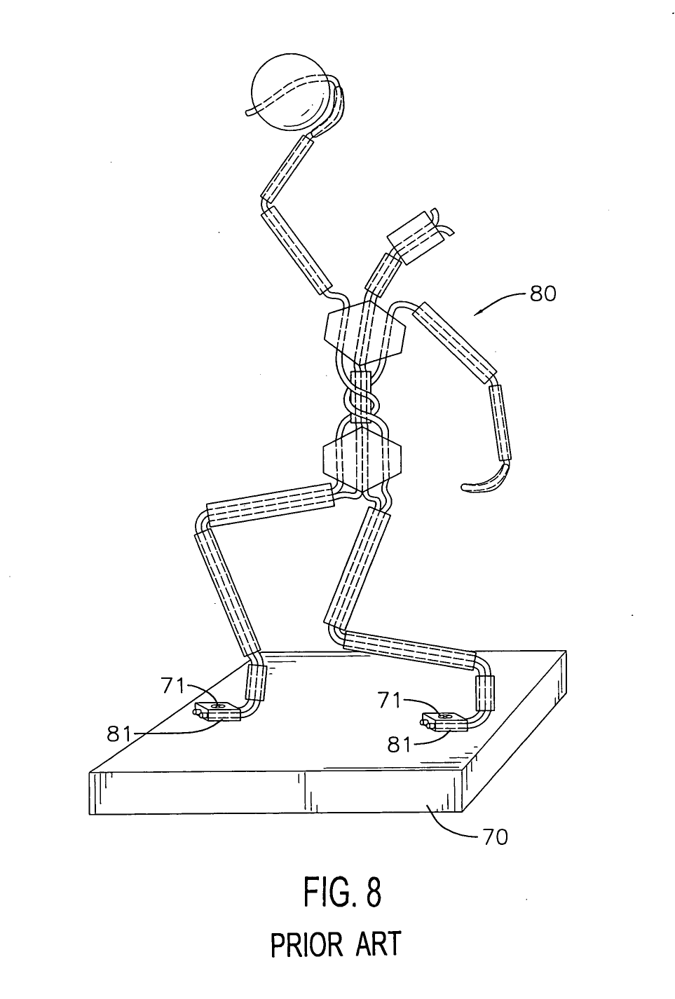

It is to be noted from FIG. 7 that when clay is applied on the skeleton (20) on top of either one of the two embodiments of the present invention, because there is not fixing element or securing element required to fix the skeleton (20) on top of the sculpture base, there is no requirement of extra manual work to secure the skeleton (20) on top of the sculpture base (10) of the present invention such that the sculpture base (10) is user friendly.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A sculpture base for supporting thereon a skeleton, the sculpture base comprising:
an inner space;
a flat top face for supporting thereon the skeleton; and
multiple through holes defined through the flat top face for extension of skeleton steel wires such that a knot is formed by the skeleton steel wires inside the inner space and the skeleton is securely supported by the flat top face.

2. The sculpture base as claimed in claim 1 further comprising a securing rod extending from a bottom face of the flat top face such that the knot is tied around the securing rod.
